(19) United States
(12) Patent Application Publication
(10) Pub. No.: US 2004/0001780 A1
(43) Pub. Date: Jan. 1, 2004

(54) Laboratory apparatus fitted with wells and used for temperature-controlling specimens

(75) Inventors: Andreas Schirr, Bad Oldesloe (DE); Andreas Graff, Hamburg (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: Eppendorf AG, Hamburg (DE)

(21) Appl. No.: 10/465,143

(22) Filed: Jun. 19, 2003

(30) Foreign Application Priority Data
Jun. 26, 2002 (DE) 102 28 431.8

(51) Int. Cl. B01L 3/00

(52) U.S. Cl. 422/99; 422/102

(57) ABSTRACT

A laboratory temperature controlling apparatus including container-like wells (2) disposed in a unit in a plane. Heating devices and cooling devices drive the wells. The wells have thin walls, and the heating devices include electrically powered heating wires that are coiled around the exterior surface of the wells. The coiled heating wires generally match an external contour of the wells. The cooling device may be a blower disposed to blow air over the exterior surface of the wells.

The invention relates to a laboratory apparatus for controlling the temperature of specimens, of the kind cited in the preamble of claim 1.

Laboratory temperature-controlling apparatus of the initially cited kind are used in temperature-controlling laboratory specimens configured in said wells. These specimens may be directly filled into the vessel-like wells. Conventionally however the specimens are held in receptacles of which the outer contour matches the inside contour of the wells and therefore said receptacles may be contained in the wells so as to generate a contact with it which is of large surface and high thermal conductivity.

Known apparatus of the above kind such as are known from

DE 196 46 115 C2 and

U.S. Pat. No. 5,525,300

configure said wells in the form of recesses in a solid and highly thermally conducting material which is fitted at its underside or at its edges with heating and cooling elements that may be mounted in separate manner or that in the form of Peltier elements also may act in both functions. Moreover, and as is the case in the above cited documents, such temperature-controlling blocks may be temperature-controlled differently at different sites in order that the block acting as a gradient block shall keep different wells at different temperatures along a temperature gradient.

The known designs incur the drawback of the large weight of the solid blocks. Not only is this block construction costly, but in particular the resulting temperature responses are very sluggish. As regards the typical application of such apparatus, namely to carry out a Polymerase Chain Reaction (PCR), the temperatures in the wells must be adjusted very rapidly. Consequently the solid block must be strongly heated or cooled. Rapid temperature changes in the known designs are possible only by recourse to very high heating and cooling inputs.

The objective of the present invention is to create apparatus of the initially cited kind which allows economical construction and very rapid changes in temperature.

This goal is attained by the features of claim 1.

The wells of the present invention are designed in the form of thin-walled containers and accordingly their mass is low. They are associated with heating coils snugly surrounding them whereby the temperatures of these wells may be raised very rapidly at low power input. Cooling also may be carried out very quickly using suitable means, for instance a cold flow of air. The wells are connected appropriately, for instance by bracing means, to a unit which can be manufactured easily and economically. Because the well walls are very thin, more economical materials may be used, which are not necessarily particularly highly thermally conductive. Moreover the individual coils may be electrically connected to be controlled jointly or individually, and as a result all wells may be arbitrarily heated in the same manner, or arbitrary individual temperature patterns may be applied to these wells.

The features of claim 2 are advantageous. The coil geometries match the wells' outer contours. The coils may be slightly spaced for instance by using appropriate spacers from the outside surface of the wells or they may be wound on and affixed directly to these outside surfaces. The direct and adjacent configurations of the heating wires therefore offer uniform heating of the entire well and low power losses.

The coils may be electrically connected in common for joint power control. The features of claim 3 are advantageous. They allow simplifying controlling the coils and the wells may be heated row for row for instance to generate a temperature gradient running transversely to these rows.

The features of claim 4 are advantageous. If the wells are linked by means of their open rim zones, the region below said rim zone remains accessible to mount the coils around it in problem-free manner.

The features of claim 5 are advantageous. In this manner the wells can be machined in a stable unit in a very simple manner. Furthermore the sealed plate above the wells protects the electrical system of coils and connecting lines against liquids spilled above said plate.

The cooling means may consist illustratively of cooling elements or Peltier elements contacting the wells. Advantageously however, the features of claim 6 may be employed. An air blower is characterized by its simple design and low costs and is able to very uniformly and efficiently cool the wells, while on the other hand heating by means of said coils allows setting arbitrary well temperatures.

The invention is shown in illustrative and schematic manner in the drawings.

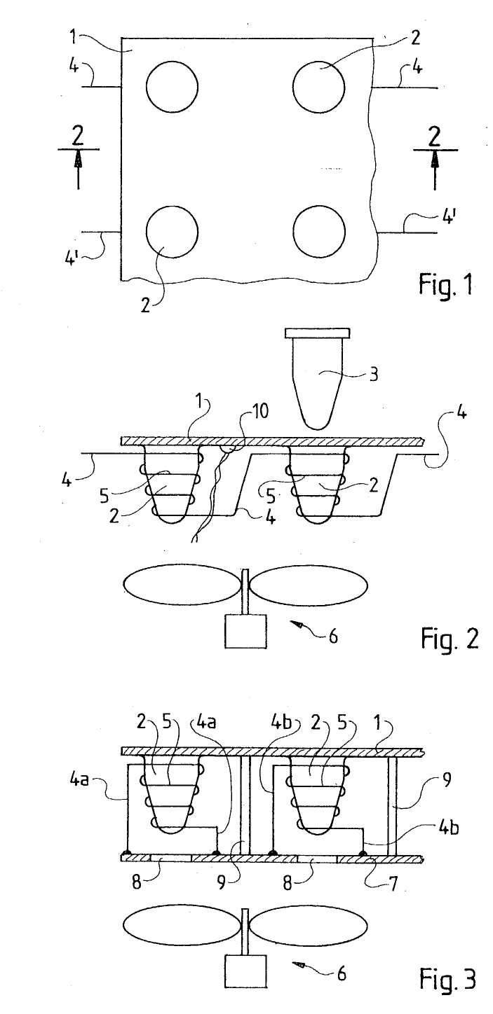

FIG. 1 is a topview of a segment of a assembly of the invention comprising several wells,

FIG. 2 is a section along line 2-2 of FIG. 1, and

FIG. 3 is a section as in FIG. 2 but of another embodiment.

A laboratory specimen temperature-controlling apparatus is shown in FIGS. 1 and 2 both in topview and in cross-section and it comprises a planar plate 1 fitted with wells 2 configured to receive geometrically matching commercial specimen receptacles 3. FIG. 2 shows the external surfaces of the wells 2 projecting below the plate 1. The well walls are very thin, being no thicker or even thinner than the plate 1 shown in FIG. 2.

FIG. 2 shows a preferably insulated heating wire 4, for example with lacquer insulation, which externally and serially runs around the two wells that are shown while forming one coil 5 at each well 2. As shown in FIG. 2, the coil geometry matches the outer contour of each well 2 which they enclose with several turns.

As regards the embodiment of FIG. 2, the heating wire 4 in the coils 5 runs a distance away from the external surface of the wells 2. Said wire is secured by omitted elements such as spacers, glue spots or the like. In another embodiment, the heating wire 4 of the coils 5 also may be wound directly on the external surface of the wells 2 and be affixed, for example by bonding.

As shown in FIG. 2, a fan 6 is mounted below the wells 2 and blows cold air against the wells and the plate 1.

The heating wire 4 of FIG. 2 runs sequentially, namely in electrical series, through both coils 5, and it is connected in omitted manner at its ends to a power source. Using omitted control elements and appropriate control procedures, any desired temperature may be set at the wells 2 by heat generation in the resistance of the heating wire 4 and by controlling the airflow from the fan 6.

Because the coils 5 are very close to the wells 2 and because of the said wells' thin walls, the specimen receptacles 3 inserted in the wells may be heated very rapidly and again may be very rapidly cooled by the fan 6 after the heat was shut off. Extremely short cycling periods may be attained with the PCR procedure.

FIG. 1 shows the plate 1 as a corner cutaway comprising four wells 2. The full plate 1 may comprise for instance the conventional 96 wells conventionally arrayed in rows and columns. Each row of wired coils may be individually controlled by a continuous heating wire 4, 4′ (FIG. 1) and consequently a temperature gradient may be set up transversely to the rows.

FIG. 3 shows an embodiment variation wherein the plate 1 fitted with the wells 2 is of the embodiment of FIG. 2. In this case too each well 2 is enclosed by a coil 5. However the heating wires 4, 4′ of the two shown coils are connected at one of their ends to conducting strips on a printed circuit board 7 running parallel to the plate 1. The conductor board 7 is fitted with perforations 8 which are situated underneath the wells and through which the blower 6 may blow air onto these wells.

In the embodiment of FIG. 3, the coils 5 make individual contact with conductor strips on the printed circuit board 7. The printed circuit board may be configured to electrically power uniformly all coils in parallel or in series or in parallel/series connection. The coils may also be connected to individual power sources and may be individually controlled or in desired groups, respectively, for instance in lines.

As shown by FIG. 3, the printed circuit board 7 may be connected by means of braces 9 with the plate 1 to constitute an assembly or unit.

Temperature feedback is required to allow temperature regulating the wells 2. For that purpose a temperature sensor 10 may be used between two wells 2 at the underside of the plate 1, as shown in FIG. 2. To increase the accuracy of measurement, temperature sensors may be used at several sites of the plate 1 or also at each well 2, in particular if these wells must be regulated individually to different temperatures.

In a variation from the shown embodiments, the wells 2 need not mandatorily be linked by a continuous plate 1. On the contrary, it suffices to interlink the wells 2 for instance using lattice-like braces so as to attain a constructively operable assembly or unit. However, as shown by FIGS. 2 and 3, the plate 1 shown in the Figures of this description offers the advantage of protecting the subjacent electric system from liquids that might be spilled for instance due to clumsy handling of the specimen receptacle 3 shown in FIG. 2.

1. A laboratory temperature controlling apparatus comprising container-like wells (2) configured in a unit in a plane, further comprising heating and cooling means (5, 6) driving said wells,
characterized in that
the wells (2) exhibit thin walls and in that the heating means include electrically powered heating wires (4a, 4b) which are configured as coils (5) surrounding the wells (2).

2. Apparatus as claimed in claim 1, characterized in that the coils (5) geometrically match the external contour of the wells (2).

3. Apparatus as claimed in claim 1, comprising wells (2) configured in rows in said plane, characterized in that the coils (5) within said rows are electrically series-connected.

4. Apparatus as claimed in claim 1, characterized in that the wells (2) are mechanically connected to each other in the zone of their aperture rims.

5. Apparatus as claimed in claim 4, characterized in that the wells (2) are impressed into a closed plate (1).

6. Apparatus as claimed in claim 1, characterized in that the cooling means is an air blower (6) blowing air onto the outside of the wells (2).
